(19) United States
(12) Patent Application Publication
(10) Pub. No.: US 2022/0391860 A1
(43) Pub. Date: Dec. 8, 2022

(54) Asset Backed Currency

(71) Applicants: John Christian Barlow, Heber City, UT (US); Michael Williams Waters, Salt Lake City, UT (US)

(72) Inventors: John Christian Barlow, Heber City, UT (US); Michael Williams Waters, Salt Lake City, UT (US)

(21) Appl. No.: 17/342,169

(22) Filed: Jun. 8, 2021

(51) Int. Cl. G06Q 20/06; G06Q 20/10; G06Q 20/38

(52) U.S. Cl. CPC G06Q 20/0655; G06Q 20/108; G06Q 20/381; G06Q 20/389

(57) ABSTRACT

What is disclosed is a system for accessing the value of real property. The system includes a real property; a computer readable medium for storing a computer program; a graphical user interface for viewing the real property and a value of the real property; a blockchain ledger, that records and stores information and transactions; cryptocurrency coins; a governing entity with authority over the possession; an issuing entity, which creates and issues cryptocurrency. The computer program communicates with the blockchain, and the computer program and blockchain are adapted to communicate with the governing entity and the issuing entity. Once the property has been entered into the program the governing entity authorizes the issuing entity to create cryptocurrency coins and issue those cryptocurrency coins to the owner of the possession. The computer program ensures that the cryptocurrency coins are recorded in the blockchain ledger.

### CROSS-REFERENCE TO RELATED APPLICATIONS

This application is a continuation in part of patent application Ser. No. 17/226,434 filed on Apr. 9, 2021, Titled Collateralization of Property Utilizing Cryptocurrency and claims priority to provisional patent application 63/024,681 filed on May 14, 2020 and titled Strategic Land Banking.

### TECHNICAL FIELD

This invention relates to Crypto Currency, Block Chain, Smart Contracts, Financial Technology, Real Property, and Investment Products.

### BACKGROUND

Many property owners have a desire to utilize equity related to their real property. Currently, there are a limited number of methods for a real property owner to utilize the equity in their real property. These methods include mortgage, home equity line of credit, and reverse mortgage. These methods are administered by financial institutions and are limited in their ability to provide funds to the owner of the real property.

### SUMMARY

In a first aspect, the disclosure provides a system for accessing the value of real property. The system includes a real property; a computer readable medium for storing a computer program; a graphical user interface for viewing the real property and a value of the real property; a blockchain ledger, that records and stores information and transactions; cryptocurrency coins; a governing entity with authority over the possession; an issuing entity, which creates and issues cryptocurrency. The computer program communicates with the blockchain, and the computer program and blockchain are adapted to communicate with the governing entity and the issuing entity. Once the property has been entered into the program the governing entity authorizes the issuing entity to create cryptocurrency coins and issue those cryptocurrency coins to the owner of the possession. The computer program ensures that the cryptocurrency coins are recorded in the blockchain ledger.

In a second aspect the disclosure provides a system for accessing the value of a possession. The system includes a possession; a computer readable medium for storing a computer program; a graphical user interface for viewing the possession and a value of the real property; a blockchain ledger, that records and stores information and transactions; cryptocurrency coins; a governing entity with authority over the possession; an issuing entity, which creates and issues cryptocurrency. The computer program communicates with the blockchain, and the computer program and blockchain are adapted to communicate with the governing entity and the issuing entity. Once the possession has been entered into the program the governing entity authorizes the issuing entity to create cryptocurrency coins and issue those cryptocurrency coins to the owner of the possession. The computer program ensures that the cryptocurrency coins are recorded in the blockchain ledger.

In a third aspect the disclosure provides a method for accessing the value of a possession. The system includes a possession; a computer readable medium for storing a computer program; a graphical user interface for viewing the possession and a value of the real property; a blockchain ledger, that records and stores information and transactions; cryptocurrency coins; a governing entity with authority over the possession; an issuing entity, which creates and issues cryptocurrency. The computer program communicates with the blockchain, and the computer program and blockchain are adapted to communicate with the governing entity and the issuing entity. Once the possession has been entered into the program the governing entity authorizes the issuing entity to create cryptocurrency coins and issue those cryptocurrency coins to the owner of the possession. The computer program ensures that the cryptocurrency coins are recorded in the blockchain ledger.

Further aspects and embodiments are provided in the foregoing drawings, detailed description, and claims.

### BRIEF DESCRIPTION OF THE DRAWINGS

The drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an embodiment of the invention utilizing residential real property.

FIG. 2 is an embodiment of the invention utilizing property rights.

FIG. 3 is an embodiment of the invention utilizing contractual rights.

FIG. 4 is an embodiment of the invention used with vehicles.

FIG. 5 is an embodiment of the invention used with art.

FIG. 6 is an embodiment of the invention used with a yacht.

FIG. 7 is an embodiment of the invention used with Patent rights.

FIG. 8a is an embodiment of the graphical user interface of the invention.

FIG. 8b is an embodiment of the graphical user interface of the invention.

FIG. 8c is an embodiment of the graphical user interface of the invention.

FIG. 9 is an embodiment of the graphical user interface of the invention.

FIG. 10 is an embodiment of the graphical user interface of the invention.

### DETAILED DESCRIPTION

The following description recites various aspects and embodiments of the inventions disclosed herein. No particular invention is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly indicates otherwise. For example, reference to “a substituent” encompasses a single substituent as well as two or more substituents, and the like.

As used herein, “for example,” “for instance.” “such as,” or “including” are meant to introduce examples that further clarify more general subject matter. Unless otherwise expressly indicated, such examples are provided only to aid in understanding embodiments illustrated in the present disclosure and are not meant to be limiting in any fashion. Nor do these phrases indicate any kind of preference for the disclosed embodiment.

As used herein “cryptocurrency” is meant to refer to a digital asset designed to work as a medium of exchange. The individual coin ownership records are stored in a computerized database known as a ledger. The ledger uses strong cryptography or cryptographic signatures to secure transaction records, to control the creation of additional coins, and to verify the transfer of coin ownership. A cryptocurrency is a system that meets six conditions: 1) the system does not require a central authority, its state is maintained through distributed consensus. 2) The system keeps an overview of currency units and their ownership. 3) The system defines whether new cryptocurrency units can be created. If new cryptocurrency units can be created, the system defines the circumstances of their origin and how to determine the ownership of these units. 4) Ownership of cryptocurrency units can be proved exclusively cryptographically. 5) The system allows transactions to be performed in which ownership of the cryptographic units is changed. A transaction statement can only be issued by an entity proving the current ownership of these units. 6) If two different instructions for changing the ownership of the same cryptographic units are simultaneously entered, the system performs at most one of them.

As used herein “smart contract” is meant to refer to a computer program or transaction protocol which is intended to automatically execute, control or document relevant events and actions in accordance with the terms of a contract or agreement. A self-executing contract with the terms of the agreement between buyer and seller being directly written into lines of code. The code and the agreements exist across a distributed, decentralized blockchain network. The code controls the execution, and transactions are trackable and irreversible. Smart contracts permit trusted transactions and agreements to be carried out among disparate, anonymous parties without the need for a central authority, legal system, or external enforcement mechanism. One area of current research is the use of the blockchain for the implementation of “smart contracts”. These are computer programs designed to automate the execution of the terms of a machine-readable contract or agreement. Unlike a traditional contract which would be written in natural language, a smart contract is a machine executable program which comprises rules that can process inputs in order to produce results, which can then cause actions to be performed dependent upon those results Examples of Bitcoin transactions are given in Alan Reiner: “Bitcoin Wallet Identity Verification Specification”. Smart contracts are particularly known from the Ethereum network, with notable explanations in Gav Wood: “Ethereum Development Tutorial. ethereum/wiki Wiki. GitHub”, in K. Ken: “Tutorial 1: Your first contract—Ethereum Community Forum”, and in “Ethereum Frontier Guide”, version of 4 Feb. 2016. Smart contracts have advantages over equivalent conventional financial instruments, including minimizing counterparty risk, reducing settlement times, and increased transparency. UBS proposed “smart bonds” that use the bitcoin blockchain in which payment streams could hypothetically be fully automated, creating a self-paying instrument. See, “Blockchain Technology: Preparing for Change”, Accenture; Ross, Rory (2015 Sep. 12). “Smart Money: Blockchains Are the Future of the Internet”, Newsweek; Wigan, David (2015 Jun. 11). “Bitcoin technology will disrupt derivatives, says banker”, IFR Asia.

As used herein “blockchain” is meant to refer to a distributed, decentralized, public ledger. Essentially, blockchain is a chain of blocks, where the “blocks” of digital information are stored in a “chain” public database. The blocks are made up of digital pieces of information and typically have three parts: 1) Stored information about transactions like the date, time, and dollar amount. 2) Stored information about who is participating in the transaction. A unique digital signature is used to identify each participant. 3) Stored information to distinguish each block from other blocks. Each block stores a unique code called a “hash” that tells a block apart from every other block. Hashes are cryptographic codes created by special algorithms. In this document we use the term ‘blockchain’ to include all forms of electronic, computer-based, peer-to-peer, distributed ledgers. These include, but are not limited to, consensus-based blockchain and transaction-chain technologies, permissioned and unpermissioned ledgers, shared ledgers and variations thereof. The most widely known application of blockchain technology is the Bitcoin ledger, although other blockchain implementations have been proposed and developed. While Bitcoin may be referred to herein for the purpose of convenience and illustration, it should be noted that the invention is not limited to use with the Bitcoin blockchain and alternative blockchain implementations and protocols fall within the scope of the present invention.

As used herein “record” is meant to refer to evidence of one or more interactions. A digital record can be electronic documentation of an interaction. A record can include a record identifier and record information. For example, record information can include information describing one or more interactions and/or information associated with the interactions (e.g., a digital signature). Record information can also include multiple data packets each of which include different data describing different interactions. A record identifier can be a number, title, or other data value used for identifying a record. A record identifier can be nondescript, in that it may not provide any meaningful information about the record information in the record. Examples of records include medical records, academic records, transaction records, credential issuance records, etc. In some embodiments, a record can be stored in a block of a blockchain. An individual block may include an individual record or a predetermined number of records, and a blockchain can be a series of records organized into blocks. Specific use of blockchain for records can be a pair of linked encryption keys. For example, a key pair can include a public key and a corresponding private key. In a key pair, a first key (e.g., a public key) may be used to encrypt a message, while a second key (e.g., a private key) may be used to decrypt the encrypted message. Additionally, a public key may be able to verify a digital signature created with the corresponding private key. The public key may be distributed throughout a network in order to allow for verification of messages signed using the corresponding private key. Public and private keys may be in any suitable format, including those based on RSA or elliptic curve cryptography (ECC). In some embodiments, a key pair may be generated using an asymmetric key pair algorithm.

As used herein “key” is meant to refer to a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

As used herein “user” is meant to refer to an entity such as a person, an organization, or a device or system associated with or operated by the person or organization that utilizes a resource for some purpose. A user may have one or more accounts that can be used to access the resource. A user may also be referred to as an account holder, a consumer, a subscriber, or a cardholder, etc., according to some embodiments.

As used herein “signature” is meant to refer to an electronic signature for a message or some data. A digital signature may be a numeric data value, an alphanumeric data value, or any other type of data including a graphical representation. A digital signature may be a unique data value generated from a message/data and a private key using an encrypting algorithm. In some embodiments, a validation algorithm employing a public key may be used to verify the signature.

As used herein “sleep compatible vehicle” is meant to refer to a vehicle with a bed or mattress in the vehicle. Such vehicles include but are not limited to RV's (Recreational Vehicles), Campervans, and other vehicles modified to accommodate a bed or mattress.

### DETAILED DESCRIPTION

Real Property can be thought of as a group of rights which can be divided from one another. These rights include but are not limited to: possession; control; use and quiet enjoyment; allow others a right to use; privacy and exclusion of others; disposition or transfer of the property to another by sale, gift, or inheritance; use of the property as collateral; water rights; surface rights; subsurface rights; air rights; development rights; improvement rights; right of equity, right to contract, right to manage, right to market, and any other rights, including negative, associated with real property ownership. The extractive, development, improvement, monetary, and investment rights are often subject to local laws, and can be subject to community regulations.

The rights most commonly used for financial gain are possession and disposition of the property. The possession of the property creates equity in the property. There are essentially three financial instruments that allow a real property owner to utilize the equity in their real property: (1) Mortgage; (2) Home Equity Line of Credit or HELOC; (3) Reverse Mortgage. Traditionally, these financial instruments are associated with lending institutions such as banks and credit unions. Generally, these institutions utilize traditional monetary systems and have not embraced cryptocurrency. There are instances of financial institutions using cryptocurrency or at least aspects of cryptocurrency but they have not adopted such methods on a wide scale. Additionally, the financial institutions' methods utilize a collateralization that will cost money and may result in foreclosure of the title.

An owner of the real property may acquire the equity in the real property by selling the real property. However, this method deprives the owner of rights associated with land ownership and future gains derived from the land ownership.

The collateralization of rights in real property for the purpose of utilizing the rights to generate currency can be implemented at different times in the life of the property ownership. For example, upon creation of a residential or commercial development, or upon the purchase of an existing residence, or upon the purchase of a commercial property.

Initially, most trade went through a barter system, one asset was traded for another. A farmer would trade his produce to a cooper for barrels or other storage containers, the cooper would also trade his wares to a fisherman for fish, and whatever assets the individual had were used to trade for the assets the individual wanted. A currency system is only valuable as long as the people utilizing the system trust that the currency has value. Throughout civilization precious metals were used as currency. The use of precious metals as currency is often referred to as commodity currency. The commodity currency has the value of the commodity in the coins. Gold and silver were the preferred forms of money, with silver typically being the main circulating medium and gold being the monetary reserve. Gold typically has a higher value than silver so there was little reason to carry around such high value currency. At some point many of the world's countries moved to a representative currency, that is the currency utilized was merely representative of the value it denominated. That is that each representative currency certificate could be redeemed for the equivalent amount of the precious metal held in that country's reserve. The United States had gold stored away, first in New York and Philadelphia, where a person holding representative currency could exchange it for actual gold. Later the gold reserves were moved to the United States Gold Bullion Depository, located at Fort Knox. In the United States each dollar printed was backed by a dollar's worth of gold in the depository. If more representative currency was to be issued, more gold was brought in (either purchased or mined) to hold the value of the representative currency. This “Gold Standard” enabled people to trust that their representative currency actually held value. The “Gold Standard” meant that paper money was freely convertible to a fixed amount of gold. The “Gold Standard” was gradually abandoned by the countries of the world, and the last vestiges of the system eliminated in 1971. Since then, the currencies of the world have been fiat currency. Fiat currencies are ultimately based on the fact that they are defined as legal tender. This decree leads to the trust that people have in the currency, a country that has a high degree of trust from its people has a high degree of trust in its currency. Fiat currencies are not only dependent upon the trust that the citizens have in the government, they are also dependent upon the decisions the government makes and the policies the government initiates. Governments can therefore make adjustments to their policies to change the value of their currency. For example, a government can print paper currency so that the market is oversaturated, this devalues that currency, meaning it takes more of the currency to purchase a given commodity.

Throughout the use of commodity currency such as gold and silver coins to the current use of fiat currency, there have been alternative methods of making asset backed payments. Instead of trading a wagon full of produce, a farmer could trade a note for the wagon full of produce. An individual could trade a title to a home instead of the home itself. These assets backed payments enabled individuals to pay with assets without the necessity of transporting those assets. There have always been those who are willing to take advantage of others and these individuals could create false assets, or assets that only existed on paper, and trade them to unsuspecting individuals. Many individuals lack the training and knowledge to identify assets that only appear on paper, this makes some asset backed instruments less appealing and less likely to be adopted. However, the value of an asset-backed currency is less likely to be adjusted by the decisions and policies of a Government or influential individuals.

One limiting factor of using assets as currency is the difficulty in dividing the asset, this is especially true of larger assets such as homes and businesses. A home is not as valuable once each brick is being traded and the home is being taken apart.

One example of how a homeowner can utilize their home as a method for generating currency is described. A residential real property is purchased. The residential real property owner desires to utilize cryptocurrency. The residential real property owner obtains market comparable studies to determine the amount of equity available for crypto collateralization. Crypto collateralization is stated as a percentage of the real property with a current dollar value, or crypto equity position. The crypto equity position is determined at the crypto collateralization and is reflective of the percentage of real property utilized for the purpose of crypto collateralization. Upon authorization from the governing entity (or a governing body which possesses the power to impose liens or other legal encumbrances on the property) and the property owner, the issuing entity creates: a blockchain title registry, cryptocurrency, account, smart contract, blockchain, and proper title documents for recordation with the local authority. Cryptocurrency coins or tokens are assigned at a valued increment against the current equity value in the subject property. The governing entity and homeowner authorize the issuing entity to create and release a stated amount of cryptocurrency for sale. The issuing entity, on behalf of the homeowner, sells the cryptocurrency and places the proceeds from the sale into an escrow account for the residential real property owner's benefit.

Another example of how a real property owner can utilize their real property as a method for generating currency is described. A nonresidential real property is purchased. The nonresidential property owner desires to utilize cryptocurrency. The nonresidential property owner obtains market comparisons to determine the amount of equity available for crypto collateralization. The crypto collateralization is stated as a percentage of the real property with a current dollar value, called a crypto equity position. The crypto equity position is determined at the time the crypto collateralization, is initiated, and is reflective of the percentage of real property utilized for the purpose of crypto collateralization. Upon authorization by a governing entity and the nonresidential real property owner the issuing entity creates: blockchain title registry; cryptocurrency account; smart contract, Blockchain, and proper title documents for recordation with the local authority. Cryptocurrency coins or tokens are assigned at a valued increment against the current equity value in the subject property. The governing entity and nonresidential property owner authorize the issuing entity to create and release an agreed upon amount of cryptocurrency for sale. The issuing entity sells the cryptocurrency and places the proceeds from the sale into an account for the real property owner's benefit.

Another example of how a real property owner can utilize their real property as a method for generating currency is described. An income property is purchased. The Income property owner desires to utilize cryptocurrency for the purpose of allocating the right of occupancy to multiple parties and providing value to the owner. The income property owner obtains studies to determine the value of the right of occupancy. The crypto collateralization is stated as a percentage of the real property right of possession as a current dollar value, called a crypto equity position. The crypto equity position is determined at the time the crypto collateralization, is initiated, and is reflective of the percentage of real property utilized for the purpose of crypto collateralization. Upon authorization from a governing entity and the income property owner, the issuing entity creates: blockchain title registry; cryptocurrency account; smart contract, Blockchain, and proper title documents for recordation with the local authority Cryptocurrency coins or tokens are assigned at a valued increment against the current equity value in the subject property. The governing entity and income property owner authorize the issuing entity to release an agreed upon amount of cryptocurrency for sale. The issuing entity sells the cryptocurrency and places the proceeds from the sale into an escrow account for the income property owner's benefit. The cryptocurrency then represents the right to occupy the real property.

Another example of how a real property owner can utilize real property as a method for generating currency is described. An individual desires to purchase a real property. The individual desires to utilize cryptocurrency. The individual obtains market comparisons to determine the amount of equity available for crypto collateralization. The crypto collateralization is stated as a percentage of the real property with a current dollar value, called a crypto equity position. The crypto equity position is determined at the time the crypto collateralization, is initiated, and is reflective of the percentage of real property utilized for the purpose of crypto collateralization. Upon authorization from a governing entity and the income property owner, the issuing entity creates: blockchain title registry; cryptocurrency account; smart contract, Blockchain, escrow account, and proper title documents for recordation with the local authority. Cryptocurrency coins or tokens are assigned at a valued increment against the current equity value in the subject property. The governing entity and income property owner authorize the issuing entity to create and release an agreed upon amount of cryptocurrency for sale. The issuing entity sells the cryptocurrency and places the proceeds from the sale into an escrow account for the purchase of the real property.

Another example of how a real property owner can utilize real property as a method for generating currency is described. A real property owner wants to allocate the use of the surface rights in the real property. The individual desires to utilize cryptocurrency for the purpose of allocating surface rights. The individual obtains market comparisons to determine the amount of equity available for crypto collateralization. The crypto collateralization is stated as a percentage of the real property with a current dollar value, called a crypto equity position. The crypto equity position is determined at the time the crypto collateralization, is initiated, and is reflective of the percentage of real property utilized for the purpose of crypto collateralization. Upon authorization from a governing entity and the income property owner, the issuing entity creates: blockchain title registry; cryptocurrency account; smart contract, Blockchain, escrow account, and proper title documents for recordation with the local authority. Cryptocurrency coins or tokens are assigned at a valued increment against the current equity value in the subject property. The governing entity and real property owner authorize the issuing entity to create and release an agreed upon amount of cryptocurrency for sale. The issuing entity sells the cryptocurrency and places the proceeds from the sale into an escrow account for the purchase of the real property. The purchasers of the crypto currency own certain rights associated with the use of the surface of the real property.

Yet another example of how a real property owner can utilize their real property as a method for generating currency is described. An income real property is purchased. The income real property owner desires to utilize cryptocurrency for the purpose of selling interests in the rental income. The income property owner obtains studies to determine the amount of equity available for crypto collateralization based on the rental value of the income property. The crypto collateralization is stated as a percentage of the income property rental value with a current dollar value, called a crypto equity position. The crypto equity position is determined at the time the crypto collateralization, is initiated, and is reflective of the percentage of real property utilized for the purpose of crypto collateralization. A governing entity and income property owner authorize the issuing entity to create: blockchain title registry; cryptocurrency account; smart contract, Blockchain, and proper title documents for recordation with the local authority. Cryptocurrency coins or tokens are assigned at a valued increment against the current rental value in the subject property. The governing entity and income property owner authorize the issuing entity to create and release an agreed upon amount of cryptocurrency for sale. The issuing entity sells the cryptocurrency and places the proceeds from the sale into an account for the real property owner's benefit. The purchasers of the cryptocurrency are entitled to receive a benefit from the rental income.

Another example of how a real property owner can utilize their real property as a method for generating currency is described. A residential real property is purchased. The homeowner desires to utilize cryptocurrency for the purpose of selling the right to market the real property. The owner obtains market comparable studies to determine the amount of equity available for crypto collateralization. Crypto collateralization is stated as a percentage of the real property with a current dollar value, or crypto equity position. The crypto equity position is determined at the crypto collateralization and is reflective of the percentage of real property utilized for the purpose of crypto collateralization. Upon authorization from the governing entity and homeowner the issuing entity creates a blockchain title registry, cryptocurrency account, smart contract, blockchain, and proper title documents for recordation with the local authority. Cryptocurrency coins or tokens are assigned at a valued increment against the current equity value in the subject property. A governing entity and homeowner authorize the issuing entity to create or mint and release a stated amount of cryptocurrency for sale and also authorizes the issuing entity to create and release a stated amount of cryptocurrency that will allow the holder of the cryptocurrency to market for sale the real property. The real property owner decides to sell the real property. The real property owner sells the cryptocurrency that has the right to market the real property to a real estate agent who now owns the right to market the property.

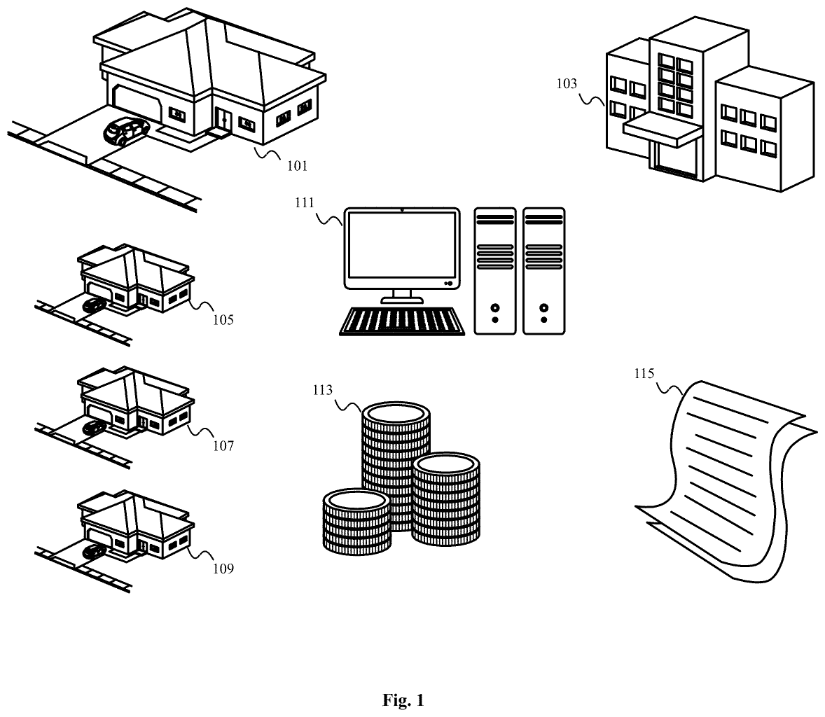

Now referring to FIG. 1 which shows one example of how the homeowner can utilize their home as a method for generating currency. A residential real property 101 is purchased. The new homeowner decides to utilize cryptocurrency. The new home owner obtains market comparable studies, for example obtaining the value of homes 105, 107, and 109, to determine the amount of equity available for crypto collateralization. These market studies take into account the comparable aspects of each home. Aspects such as; the size of each of the homes, the location of each of the homes, the age of each of the homes, the size of the land attached to each of the homes. The studies endeavor to quantify these aspects and define a picture of the value of the new homeowner's real property. Once the studies have been carried out, a value is assigned to the real property. When the real property has been assigned a value, a governing entity 103 presents this to the homeowner. The homeowner decides the amount of currency they wish to obtain. The governing entity 103 submits the value and the request for collateralization to the issuing entity, which begins the currency issue process. The amount the homeowners wishes to obtain in crypto collateralization is stated as a percentage of the real property with a current dollar value. The crypto equity position is determined at the crypto collateralization and is reflective of the percentage of real property utilized for the purpose of crypto collateralization. The issuing entity creates: block chain title registry 111, crypto currency 113, account, smart contract 115, block chain and smart contract hyper ledger. Crypto currency coins 113 are assigned valued increment against the current equity value in the subject property, essentially upon assignment, each cryptocurrency coin 113 is worth One Dollar (UDS$1.00) of the assigned value of the real property. The homeowner and the governing entity 103 authorize the issuing entity to release a stated amount of crypto currency for sale. The issuing entity mediates the sale of the crypto currency 113 and places the proceeds from the sale into an escrow account for the residential real property owner's benefit.

In some embodiments, the equity become a liquid asset for the homeowner, where the homeowner can use the amount of equity for whatever they desire while forgoing the actual ownership of that equity. When a homeowner decides to place a residential property up for collateralization the governing entity initiates the protocol for the collateralization process. This protocol imports all the details of the property and the current encumbrances on the property, to the issuing entity. Once all of the details of the property are entered into the protocol, the property is collateralized with crypto currency and each coin of the cryptocurrency is valued at approximately one U.S. dollar. For example, a property that is valued at $500,000 would issue 500,000 coins. The coins are placed in an auction. Those who want to buy the coins can bid on them in the auction. The protocol will sell the coins at the auction. Even if there is a mortgage on the property, the coins will sell for the full value of the equity in the property. The proceeds from the sale will be used to pay off the mortgage, and the amount of equity owned by the property owner will be paid to the property owner. The property owner will then have the amount of their equity to use in whatever manner they wish. The homeowner will still maintain the right to occupancy and may have a payment to the issuing entity to maintain that right to occupancy.

A monetary event, such as sale of the property will result in a cashing out of the coins related to that property. All purchased coins related to that property will be paid at the current value of the coins purchased.

In some embodiments, the governing entity is an HOA, and the issuing entity is an organization developed for the issuing and oversight of the cryptocurrency. In other embodiments, the governing and issuing entities are the same company. In many embodiments where the governing and issuing entities are the same entity, that entity is an HOA.

In an alternative embodiment, the currency is a currency other than cryptocurrency. A residential real property 101 is purchased. The new homeowner decides to utilize asset backed currency. The new homeowner obtains market comparable studies, for example obtaining the value of homes 105, 107, and 109, to determine the amount of equity available in the property. These market studies take into account the comparable aspects of each home. Aspects such as; the size of each of the homes, the location of each of the homes, the age of each of the homes, the size of the land attached to each of the homes. The studies endeavor to quantify these aspects and define a picture of the value of the new homeowner's real property. Once the studies have been carried out, a value is assigned to the real property. When the real property has been assigned a value, a governing entity 103 presents this to the homeowner. The homeowner decides the amount of currency they wish to obtain. The governing entity 103 submits the value and the request for currency to the issuing entity, which begins the currency issue process. The amount the homeowners wishes to obtain in currency is stated as a percentage of the real property with a current dollar value. The equity position is determined at the time of the valuation and the minting of the currency and is reflective of the percentage of real property utilized for the purpose of currency creation. The issuing entity creates title registry 111, currency 113, account, contract 115. Currency such as coins 113 are assigned valued increment against the current equity value in the subject property, essentially upon assignment, each currency coin 113 is worth One Dollar (UDS$1.00) of the assigned value of the real property. The homeowner and the governing entity 103 authorize the issuing entity to release a stated amount of currency for sale. The issuing entity mediates the sale of the currency 113 and places the proceeds from the sale into an escrow account for the residential real property owner's benefit.

In some embodiments, the governing entity and the issuing entity are the same entity. In some embodiments, the governing and issuing joint entity is a bank.

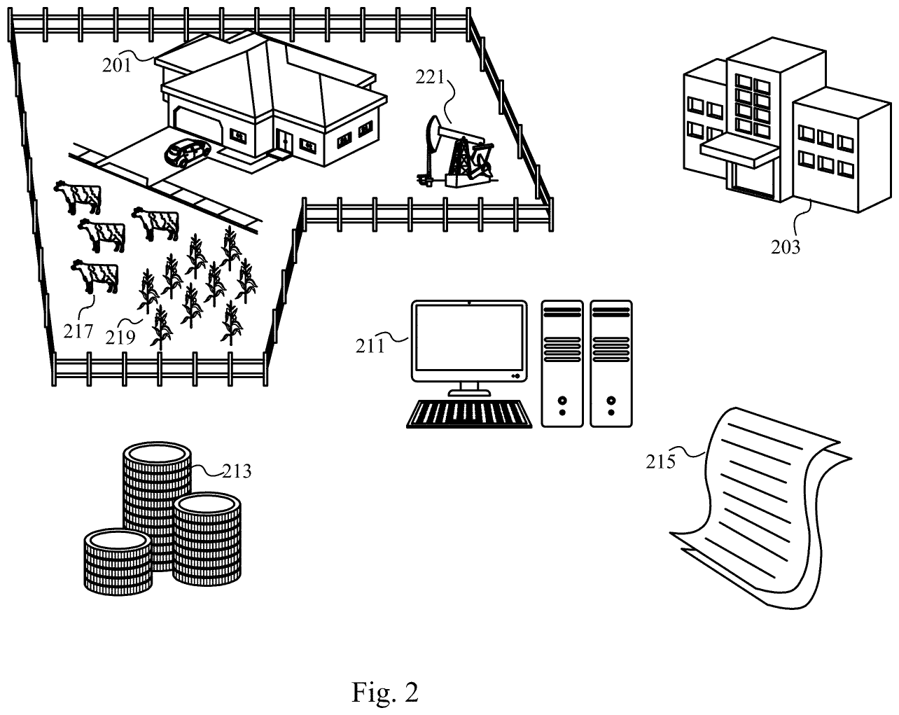

Now referring to FIG. 2 which shows an example of how the homeowner can utilize their home as a method for generating currency. A residential real property 201 is purchased. The new homeowner decides to utilize cryptocurrency to monetize their rights in the real property. Rights in property include surface rights. Surface rights allow the homeowner to utilize the surface of their property. Often the use of surface rights is utilized through agriculture. The use can be growing crops, raising livestock, or both. In many instances surface rights are leased to others. A homeowner can decide to utilize these surface rights through cryptocurrency collateralization. The new property owner obtains market comparable studies, to determine the amount of equity available for crypto collateralization. These market studies take into account the comparable aspects of the surface rights. Aspects such as: the size of each piece of land; the location of each piece of land; the soil composition of each piece of land; the likely use of the land; and the value of the use to which the land will be put. For example, the land could be in a location that is well suited to growing corn 219. The market study would then focus on corn for the comparison. The comparison would specify the market rate for the sale of corn, the cost to grow the corn, and possible other uses such as entertainment like corn mazes. Alternatively, the land might be better suited to raising cattle 217. The market studies would then focus on cattle raising. The studies endeavor to quantify these aspects and define a picture of the value of the new home owner's surface rights. Once the studies have been carried out a value is assigned to the surface rights. When the surface rights have been assigned a value, a governing entity 203 presents this to the homeowner. The homeowner decides the amount of currency they wish to obtain. The issuing entity begins the currency issue process. The amount the homeowners wishes to obtain in Crypto collateralization is stated as a percentage of the surface rights with a current dollar value. The crypto equity position is determined at the crypto collateralization and is reflective of the percentage of surface rights utilized for the purpose of crypto collateralization. The issuing entity creates: block chain title registry 211, crypto currency 213, account, smart contract 215, block chain and smart contract hyper ledger. Crypto currency coins 213 are assigned at a specific stated value against the current equity value in the surface rights, essentially each cryptocurrency coin 213 is worth approximately one dollar ($1.00) of the assigned value of the surface rights. The homeowner and a governing entity authorize the issuing entity to release a stated amount of cryptocurrency for sale. The issuing entity lists the cryptocurrency 213 for sale and places the proceeds from the sale into an escrow account for the real property owner benefit.

In some embodiments, the property owner desires the surface rights become a liquid asset for the property owner, where the property owner can use the value of the surface rights for whatever they while forgoing the actual ownership of those rights. When a property owner decides to place the surface rights of a property up for collateralization the governing entity initiates the protocol for the collateralization process. This protocol imports all the details of the property and the current encumbrances on the property, to the issuing entity. Once all of the details of the property are entered into the protocol run by the issuing entity, the surface rights of the property are collateralized with crypto currency and each coin of the cryptocurrency is valued at approximately one U.S. dollar. For example, a property with surface rights that are valued at $1,000,000.00 would issue 1,000,000 coins. The coins are placed in an auction. Those who want to buy the coins can bid on them in the auction. The protocol will sell the coins at the auction. Even if there is a mortgage on the property, the coins will sell for the full value of the surface rights in the property. The proceeds from the sale will be used to pay off the mortgage, and the amount left over after paying the mortgage will be paid to the property owner. The property owner will then have the amount from the collateralization of the surface rights minus the cost of the mortgage to use in whatever manner they wish. The property owner will still maintain other rights to the property.

A monetary event, such as sale of the property will result in a cashing out of the coins related to that property. All purchased coins related to that property will be paid at the current value of the coins purchased.

Alternatively, the real property owner decides to utilize cryptocurrency for subsurface rights. Subsurface rights allow the homeowner to utilize what is found under the surface of their property, which includes mineral and oil rights. In many instances subsurface rights are leased to others. A real property owner can decide to utilize these subsurface rights through cryptocurrency collateralization. The property owner can establish a valuation of the subsurface rights through one of several methods. In one embodiment, the property owner obtains market comparable studies, to determine the amount of equity available for crypto collateralization. These market studies take into account the comparable aspects of the subsurface rights. Aspects such as: the size of each piece of land; the location of each piece of land; the soil composition of each piece of land; the likely use of the land; and the value of the use to which the land will be put. For example, the land could be in a location that is known to have deposits of coltan, which contains tantalum. Tantalum is used in the production of capacitors, such as those found in cell phones, computers, and cameras. The market study would then focus on coltan for the comparison. The comparison would specify the market rate for the sale of coltan, the cost to extract the coltan, and possible other uses. Alternatively, the land might be better suited to oil drilling 221. The market studies would then focus on oil. The studies endeavor to quantify these aspects and define a picture of the value of the new homeowner's subsurface rights. Once the studies have been carried out, a value is assigned to the subsurface rights. Particularly with respect to oil drilling 221 a different study such as a well size study could be utilized. These studies may use technology to determine the size of the well and approximate the amount of oil in the well. These well size studies will then assign a value to the subsurface oil rights. When the subsurface rights have been assigned a value, the governing entity presents this to the real property owner. The real property owner decides the amount of currency they wish to obtain. The issuing entity begins the currency issue process. The amount the real property owner wishes to obtain in crypto collateralization is stated as a percentage of the sub surface rights with a current dollar value. The crypto equity position is determined at the crypto collateralization and is reflective of the percentage of sub surface rights utilized for the purpose of crypto collateralization. The governing entity and property owner authorize the issuing entity to create block chain title registry 211, crypto currency 213, account, smart contract 215, block chain and smart contract hyper ledger. Crypto currency coins 213 are assigned a specific stated value against the current equity value in the subsurface rights, essentially, upon collateralization, each cryptocurrency coin 213 is worth approximately one dollar ($1.00) of the assigned value of the subsurface rights. The real property owner and the governing entity 203 authorizes the issuing entity to release a stated amount of cryptocurrency for sale. The issuing entity is then authorized to sell the cryptocurrency 213 and places the proceeds from the sale into an escrow account for the real property owner's benefit.

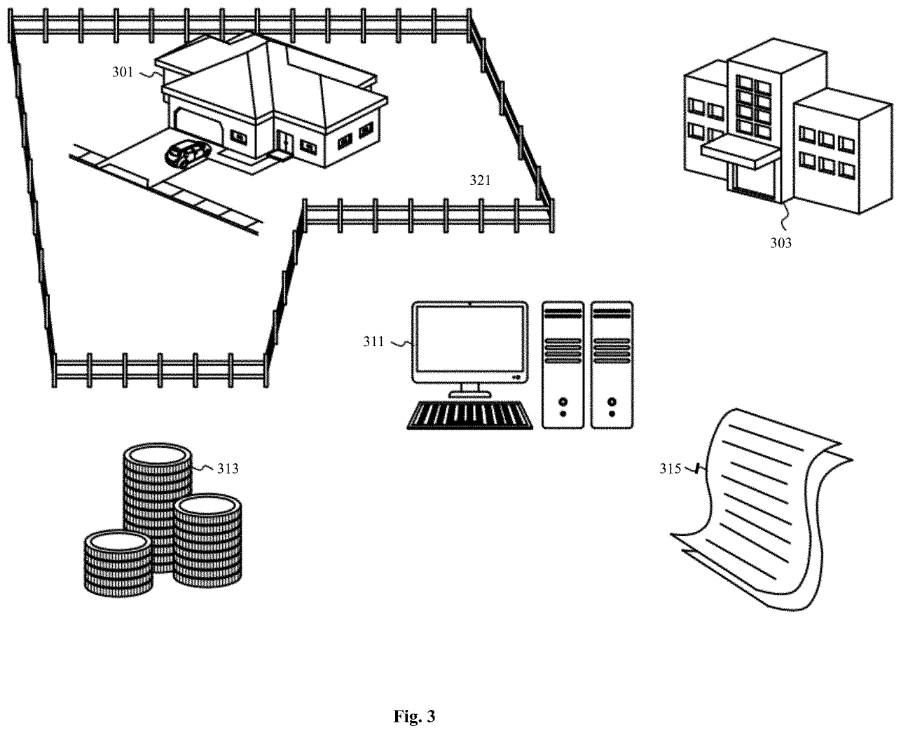

Now referring to FIG. 3, the homeowner decides to utilize cryptocurrency for contractual rights. Contractual rights allow the homeowner to utilize others to perform services on the real property, which includes painting, maintenance, improvements, development, or marketing the real property for sale. In many instances contractual rights are granted to other vendors who manage the property. A homeowner can decide to utilize these rights through cryptocurrency collateralization. The homeowner can establish a valuation of the contractual rights through one of several methods. In one embodiment, the property owner obtains market comparable studies, to determine the amount of equity in the contractual rights available for crypto collateralization. These market studies take into account the comparable aspects of the contractual rights. Aspects such as: the predominant nature of use of the real property; the location of the real property; the amount of improvement to be done to the real property; the likely value of the improved real property; and the value of the services of a real estate marketing agent. For example, the land could be raw land which is in a good location for development. The market study would then focus on other developments for comparison. The comparison would specify the market rate for the sale of developed land, the cost to develop the land, and possible other uses for the land. Alternatively, the land might be better suited to be set aside for environmental easements. The market studies would then focus on potential tax credits and resale value. The studies endeavor to quantify these aspects and define a picture of the value of the homeowner's contractual rights. Once the studies have been carried out, a value is assigned to the different contractual rights as it pertains to the use of the property. Particularly with respect to environmental easement 321 a different study such as potential tax credits or resale value could be utilized. These studies could be based on tax codes or prior resale values for land with environmental designations. These studies will then assign to the contractual rights a value for each such right. When the contractual rights have been assigned a value, the governing entity 303 presents this to the property owner. The property owner decides the amount of currency they wish to obtain. The governing entity and real property owner authorize the issuing entity to begin the currency issue process. The amount the homeowner wishes to obtain in crypto collateralization is stated as a percentage of the contractual rights with a current dollar value. The crypto equity position is determined at the crypto collateralization and is reflective of the percentage of contractual rights utilized for the purpose of crypto collateralization. The homeowner and the governing entity authorize the issuing entity to create: blockchain title registry 311, crypto currency 313, account, smart contract 315, blockchain and smart contract hyper ledger. Cryptocurrency coins 313 are assigned a specific stated value against the current equity value in the contractual rights, essentially, upon collateralization, each cryptocurrency coin 313 is worth one dollar ($1.00) of the assigned value of the contractual rights. The real property owner and the governing body of the housing development 303 authorize the issuing entity to release a stated amount of cryptocurrency for sale. The issuing entity is then authorized to sell the cryptocurrency 313 and places the proceeds from the sale into an escrow account for the real property owner's benefit.

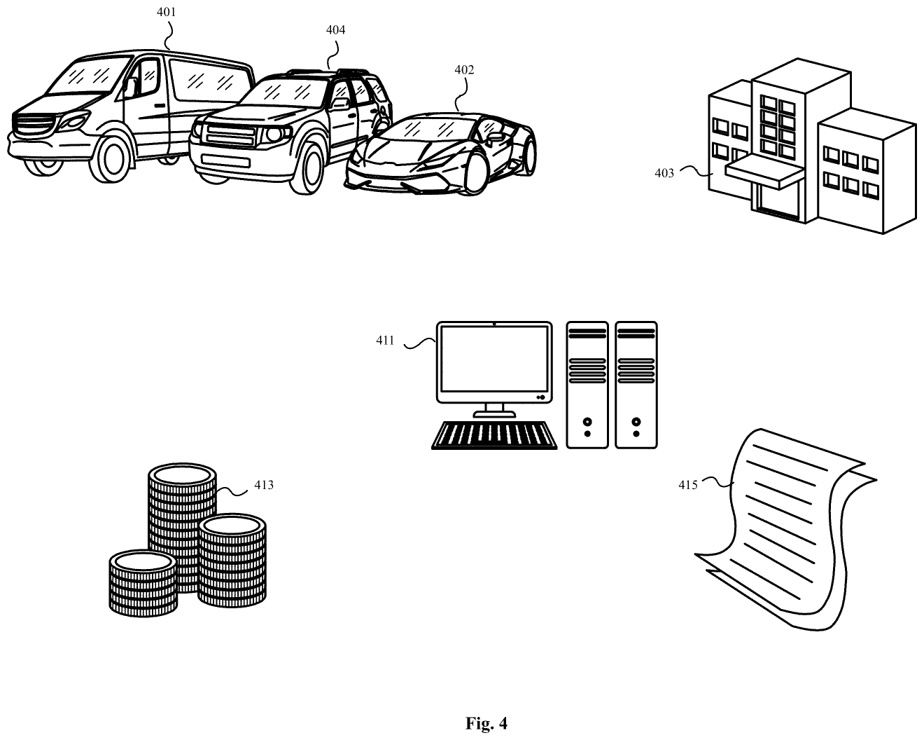

The use of the present invention is not limited to real estate and land options. The same system can be applied to other forms of property. Now referring to FIG. 4 which shows one example of the use of the system with regard to other properties. In this embodiment, the owner of an automobile, such as a high-end sport car, an RV, a camper van, or other automobile, decides to collateralize the automobile. The value of the automobile is determined through the use of studies of market comparable vehicles. For example, the owner of campervan 401 decides to collateralize the campervan 401. Possessions such as vehicles are subject to less rights than real estate. The bundle of rights associated with a campervan would generally be merely possession of the campervan, through collateralization the rights could be expanded to include possession, or ownership, and rents. The owner of the campervan could rent out the campervan for as little time as they liked to as long as they still maintained possession of the campervan. Once the studies have been carried out, a value is assigned to the campervan. When the campervan has been assigned a value, a governing entity 403 presents this to the owner. The owner decides the amount of currency they wish to obtain. The governing entity 403 submits the value and the request for collateralization to the issuing entity, which begins the currency issue process. The amount the owner wishes to obtain in crypto collateralization is stated as a percentage of the campervan with a current dollar value. The crypto equity position is determined at the crypto collateralization and is reflective of the percentage of the value of the campervan utilized for the purpose of crypto collateralization. The issuing entity creates block chain title registry 411, crypto currency 413, account, smart contract 415, block chain and smart contract hyper ledger. Crypto currency coins 413 are assigned valued increment against the current equity value in the campervan, essentially upon assignment, each cryptocurrency coin 413 is worth One Dollar (UDS$1.00) of the assigned value of the campervan. The campervan owner and the governing entity 403 authorize the issuing entity to release a stated amount of crypto currency for sale. The issuing entity mediates the sale of the crypto currency 413 and places the proceeds from the sale into an escrow account for the camp e ry an owner's benefit.

In another embodiment, the owner of a high-end sports car 402 desires to collateralize the car. The process through the system is the same. The high-end car is compared against similar vehicles and a value is assigned to the vehicle.

In another embodiment, the owner of a typical car such as an SUV 404 desires to collateralize the car. The process through the system is the same as described above.

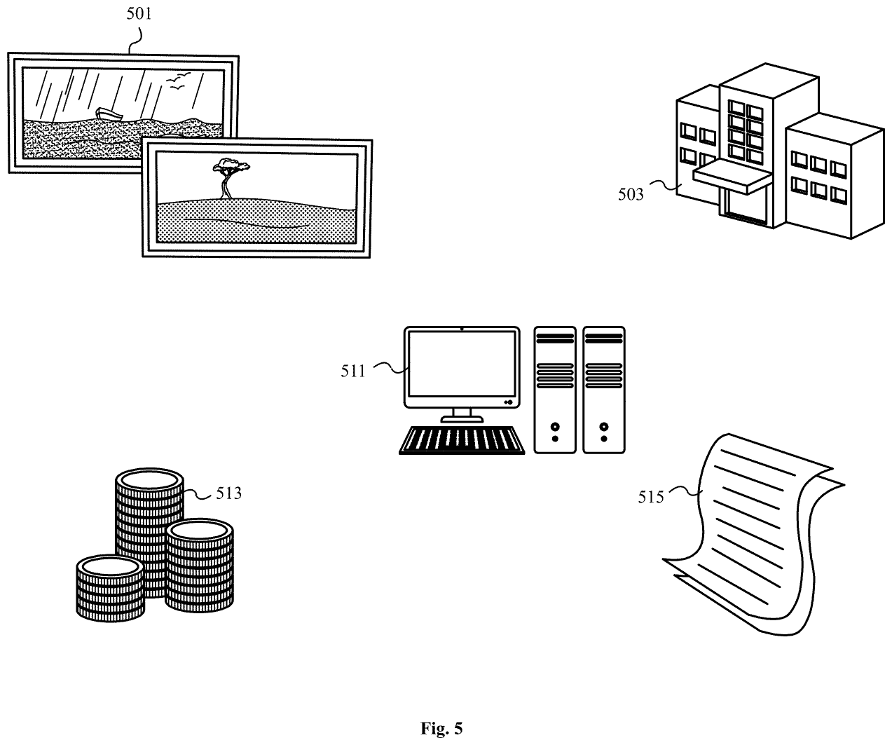

Another form of property with which the system is used is yachts. Now referring to FIG. 5 which shows one embodiment of the use of the system with regard to other properties. In this embodiment, the owner of a yacht decides to collateralize the yacht. The value of the yacht is determined through the use of studies of market comparable vehicles. For example, the owner of yacht 501 decides to collateralize the yacht 401. Possessions such as vehicles are subject to less rights than real estate. The bundle of rights associated with a yacht would generally be merely possession of the yacht, through collateralization, the rights could be expanded to include possession, or ownership, and rents. The owner of the yacht could rent out the yacht for as little time as they liked, as long as they still maintained possession of the yacht. Once the studies have been carried out, a value is assigned to the yacht. When the yacht has been assigned a value, a governing entity 503 presents this to the owner. The owner decides the amount of currency they wish to obtain. The governing entity 503 submits the value and the request for collateralization to the issuing entity, which begins the currency issue process. The amount the owner wishes to obtain in crypto collateralization is stated as a percentage of the yacht with a current dollar value. The crypto equity position is determined at the crypto collateralization and is reflective of the percentage of the value of the yacht utilized for the purpose of crypto collateralization. The issuing entity creates block chain title registry 511, crypto currency 513, account, smart contract 515, block chain and smart contract hyper ledger. Crypto currency coins 513 are assigned valued increment against the current equity value in the subject yacht, essentially upon assignment, each cryptocurrency coin 513 is worth One Dollar (UDS$1.00) of the assigned value of the yacht. The campervan owner and the governing entity 503 authorize the issuing entity to release a stated amount of crypto currency for sale. The issuing entity mediates the sale of the crypto currency 513 and places the proceeds from the sale into an escrow account for the yacht owner's benefit.

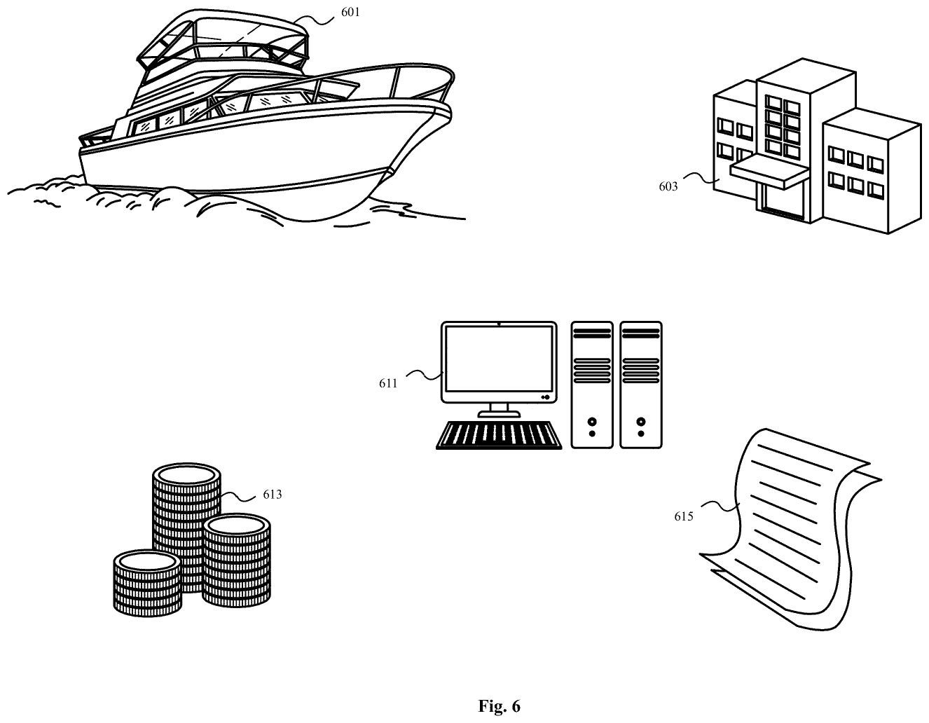

In yet another embodiment, the system is used in connection with art. Now referring to FIG. 6 which shows one embodiment of the use of the system with regard to other properties. In this embodiment, the owner of piece of art decides to collateralize the art. The value of the piece of art is determined through the use of studies of market comparable pieces of art. For example, the owner of painting 601 decides to collateralize the art 601. Possessions such as art are subject to less rights than real estate. The bundle of rights associated with a piece of art would generally be merely possession of the piece of art, through collateralization, the rights could be expanded to include possession, or ownership, and rents. The owner of the painting could rent the piece of art for as little time as they liked, as long as they still maintained possession of the piece of art. Once the studies have been carried out, a value is assigned to the painting. When the painting has been assigned a value, a governing entity 603 presents this to the owner. The owner decides the amount of currency they wish to obtain. The governing entity 603 submits the value and the request for collateralization to the issuing entity, which begins the currency issue process. The amount the owner wishes to obtain in crypto collateralization is stated as a percentage of the painting with a current dollar value. The crypto equity position is determined at the crypto collateralization and is reflective of the percentage of the value of the painting utilized for the purpose of crypto collateralization. The issuing entity creates block chain title registry 611, crypto currency 613, account, smart contract 615, block chain and smart contract hyper ledger. Crypto currency coins 613 are assigned valued increment against the current equity value in the subject painting, essentially upon assignment, each cryptocurrency coin 613 is worth One Dollar (UDS$1.00) of the assigned value of the painting. The painting owner and the governing entity 603 authorize the issuing entity to release a stated amount of crypto currency for sale. The issuing entity mediates the sale of the crypto currency 613 and places the proceeds from the sale into an escrow account for the painting owner's benefit.

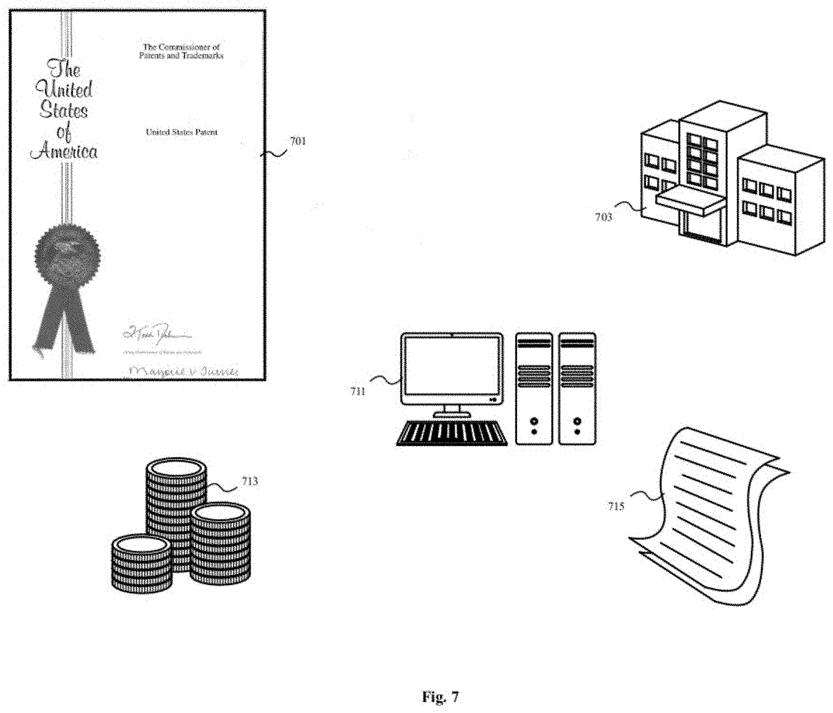

In yet another embodiment, the system is used in connection with intellectual property, such as patents, trademarks, copyrights, or portfolios of each type of intellectual property. Now referring to FIG. 7, the owner of a patent or portfolio of patents decides to collateralize the patent or portfolio of patents. The value of the patent is determined through the use of studies of market comparable patents. For example, the owner of patent 701 decides to collateralize the patent 701. Possessions such as patents are subject to less rights than real estate. The bundle of rights associated with a patent would generally be right to exclude others. The owner of the patent could license the patent for as little time as they liked to as long as they still maintained possession of the patent. Once the studies have been carried out, a value is assigned to the patent. When the patent has been assigned a value, a governing entity 703 presents this to the owner. The owner decides the amount of currency they wish to obtain. The governing entity 703 submits the value and the request for collateralization to the issuing entity, which begins the currency issue process. The amount the owner wishes to obtain in crypto collateralization is stated as a percentage of the value of the patent or patent portfolio with a current dollar value. The crypto equity position is determined at the crypto collateralization and is reflective of the percentage of the value of the patent utilized for the purpose of crypto collateralization. The issuing entity creates block chain title registry 711, crypto currency 713, account, smart contract 715, block chain and smart contract hyper ledger. Crypto currency coins 713 are assigned valued increment against the current equity value in the subject patent or patent portfolio, essentially upon assignment, each cryptocurrency coin 713 is worth One Dollar (UDS$1.00) of the assigned value of the patent. The patent owner and the governing entity 703 authorize the issuing entity to release a stated amount of crypto currency for sale. The issuing entity mediates the sale of the crypto currency 713 and places the proceeds from the sale into an escrow account for the patent owner's benefit.

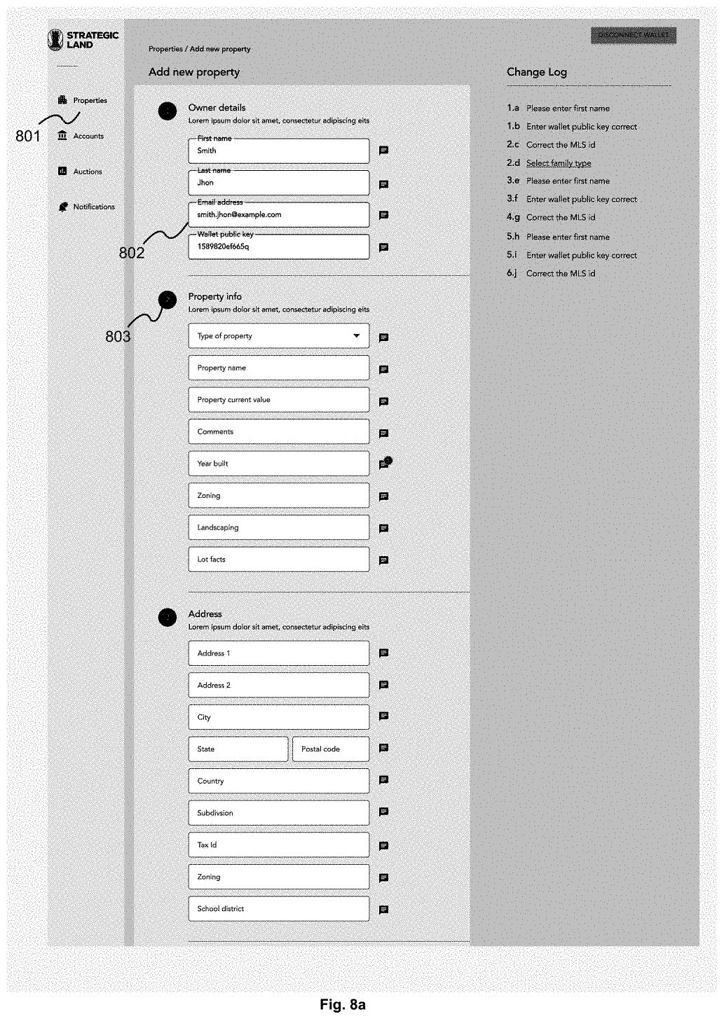

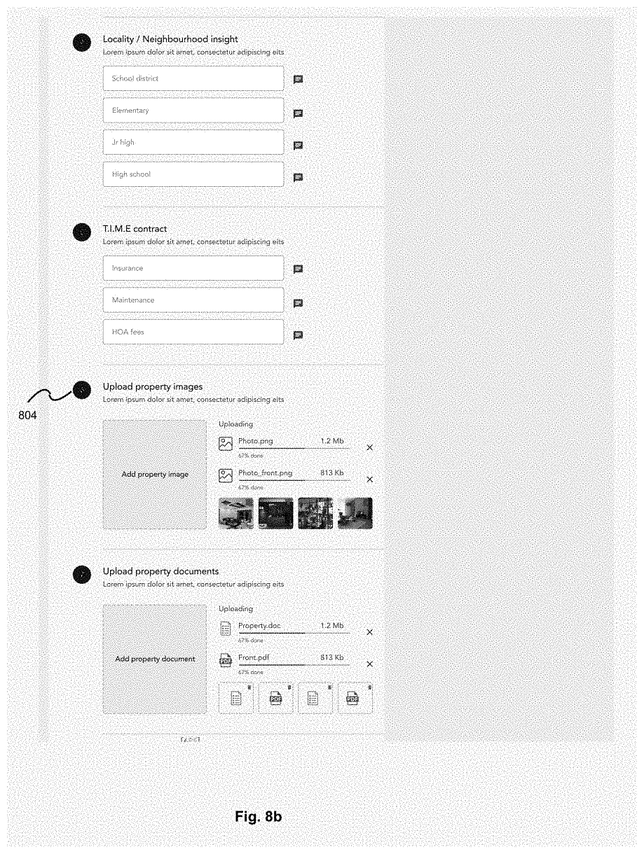

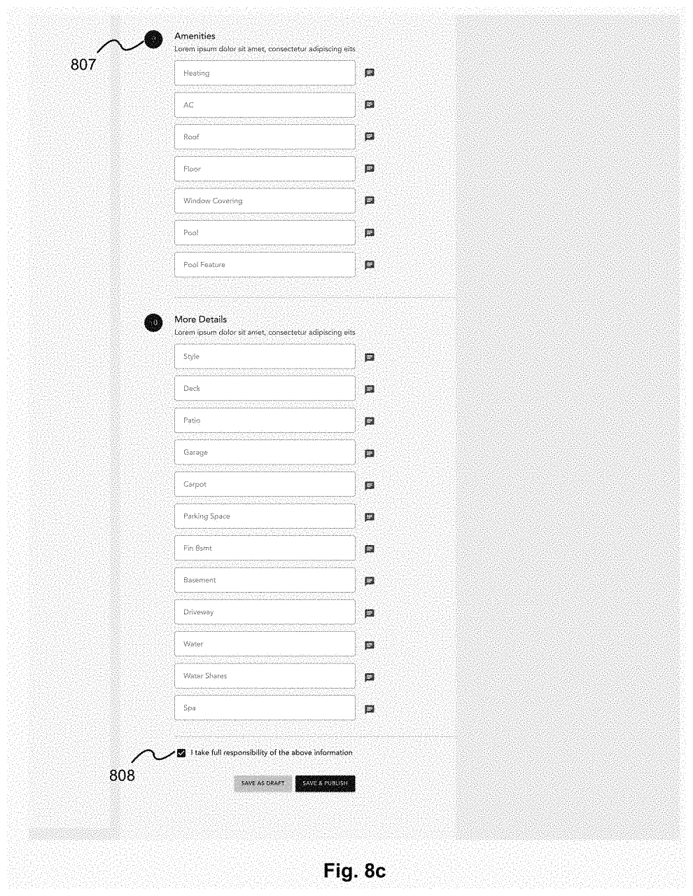

Now referring to FIGS. 8A-8C. A protocol for assisting a user and for determining the currency available to the user is implemented on a computing device. In certain embodiments the protocol is implemented on a personal computer. In other embodiments the protocol is implemented on a smartphone (iPhone, android, etc.) or a tablet computing device. In yet other embodiments the protocol is implemented on in a cloud-based system. The protocol includes a graphical user interface with which a user interacts. The user protocol remains the same without regard to the device on which the protocol is run. A real property owner utilizes the graphical user interface to input the property data required by the protocol. The data required is information that pertains to the property, such as owner details 801 including their wallet public key 802, property information 803, property images 804, property documents 805, property configuration 806, property amenities 807, additional details, and owner acceptance 808. The above is not inclusive of the information required, it is just an example of the information required.

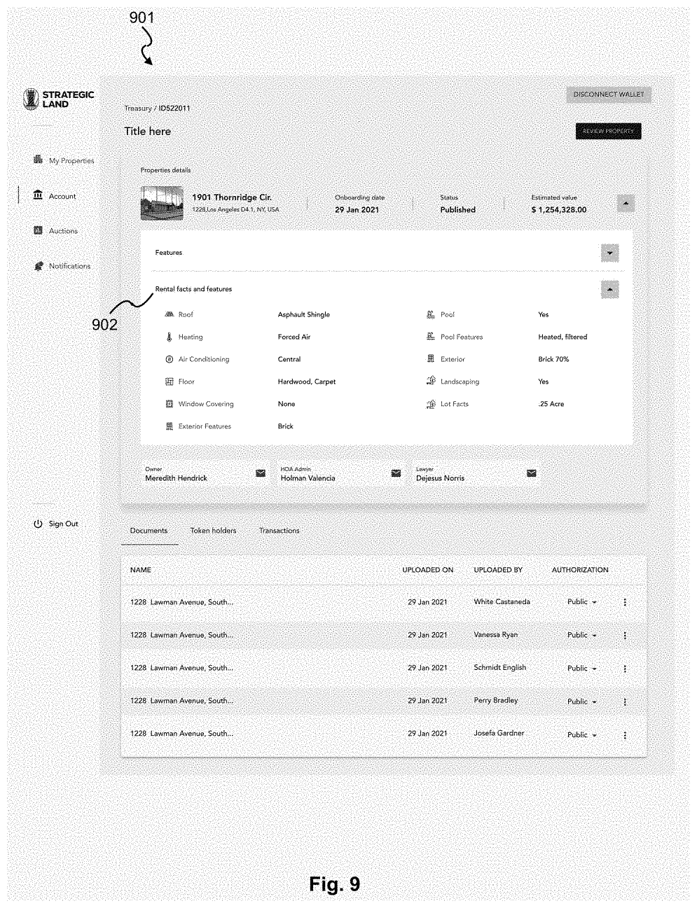

Now Referring to FIG. 9. The computer protocol creates a profile of the property for the purpose of creating a blockchain title registry, cryptocurrency, account, smart contract, blockchain and smart contract hyper ledger, and proper title documents for recordation with the local authority. The profile 901 as seen in the graphical user interface includes the features of the property 902 such as how the house is heated, what type of shingles are on the roof, what type of floor, any outside features, and many other options. The graphical user interface shows these aspects in a clearly visible and understandable representation so that the user can clearly understand and interpret the data in the profile.

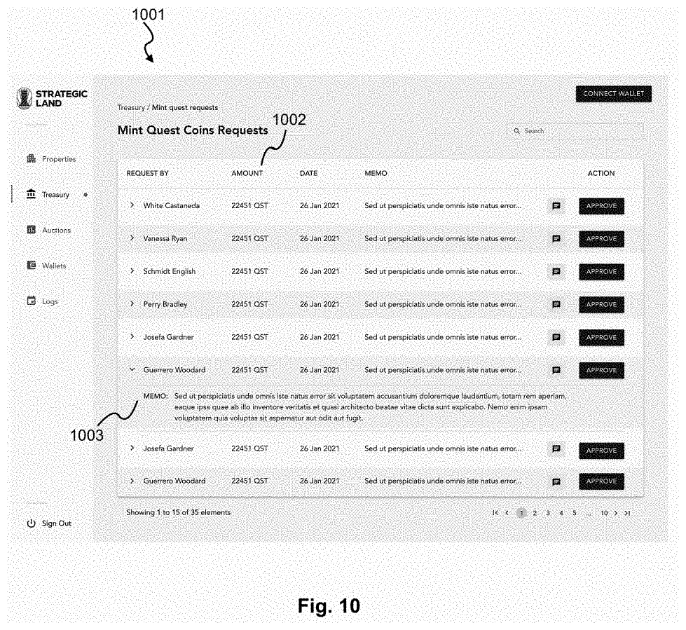

Now referring to FIG. 10. The property owner can request cryptocurrency coins 1001. Depending on the method the homeowner has chosen to collateralize their property, the homeowner requests cryptocurrency. The cryptocurrency coins are minted based on the value of the portion of the property requested by the homeowner. The cryptocurrency coins or tokens are assigned at a valued increment against the current equity value in the subject property 1002. The protocol determines what action 1003 to take relative to the request. The actions include approve the request, deny the request, and request more data related to the request.

The invention has been described utilizing real estate or real property. The invention can be used in conjunction with other types of property or possessions. Examples include, but are not limited to; automobiles, art, gold, silver, minerals, precious gems, or other possessions.

All patents and published patent applications referred to herein are incorporated herein by reference. However, any reference to prior publication is not, and should not be taken as an acknowledgement, admission, or suggestion that the prior publication, or any information derived from it is part of the general common knowledge in the field of endeavor to which this specification relates. The invention has been described with reference to various specific and preferred embodiments and techniques. Nevertheless, it is understood that many variations and modifications may be made while remaining within the spirit and scope of the invention.

[No new matter has been added]

What is claimed is:

1. A system for accessing a value of equity in a real property comprising:
a real property;
a computer readable medium for storing a computer program;
a graphical user interface for viewing real property and a value of the real property;
a blockchain ledger, that records and stores information and transactions;
cryptocurrency coins;
a governing entity with authority over the real property;
an issuing entity, which creates and issues cryptocurrency;
wherein the computer program communicates with the blockchain, and the computer program and blockchain are adapted to communicate with the governing entity and the issuing entity;
wherein once the property has been entered into the program the governing entity authorizes the issuing entity to create cryptocurrency coins and issue those cryptocurrency coins to the owner of the real property;
wherein the computer program ensures that the cryptocurrency coins are recorded in the blockchain ledger.

2. The invention of claim 1, wherein the value of each cryptocurrency coin is equivalent to approximately one US dollar.

3. The invention of claim 1, wherein the amount of cryptocurrency issued to the owner of the real property is a fraction of the determined value of the real property.

4. A system for accessing a value of equity in a possession comprising:
a possession;
a computer readable medium for storing a computer program;
a graphical user interface for viewing the possession and a value of the real property;
a blockchain ledger, that records and stores information and transactions;
cryptocurrency coins;
a governing entity with authority over the possession;
an issuing entity, which creates and issues cryptocurrency;
wherein the computer program communicates with the blockchain, and the computer program and blockchain are adapted to communicate with the governing entity and the issuing entity;
wherein once the possession has been entered into the program the governing entity authorizes the issuing entity to create cryptocurrency coins and issue those cryptocurrency coins to the owner of the possession;
wherein the computer program ensures that the cryptocurrency coins are recorded in the blockchain ledger.

5. The invention of claim 4, wherein the possession is a vehicle.

6. The invention of claim 5, wherein the vehicle is a sleep compatible vehicle.

7. The invention of claim 4, wherein the possession is art.

8. The invention of claim 7, wherein the art is a painting.

9. The invention of claim 7, wherein the art is a statue.

10. The Invention of claim 4, wherein the possession is a yacht.

11. The invention of claim 4, wherein the possession is intellectual property.

12. The invention of claim 11, wherein the intellectual property is a patent.

13. The invention of claim 11, wherein the intellectual property is a portfolio of patents.

14. The invention of claim 11, wherein the intellectual property is a trademark.

15. The invention of claim 11, wherein the intellectual property is a portfolio of trademarks.

16. A currency backed by real property comprising:
a real property;
an entity with authority over the real property and the authority to issue a currency;
wherein the entity attaches a lien to the real property for the value of the property;
wherein the entity issues currency based upon the value of the property.

17. The invention of claim 16, further comprising;
a computer readable medium for storing a computer program;
a graphical user interface for viewing the possession and a value of the real property;
a blockchain ledger, that records and stores information and transactions; an issuing entity, which creates and issues cryptocurrency;
wherein the computer program communicates with the blockchain,
wherein once the property has been entered into the program the entity authorizes the creation of cryptocurrency coins and issue those cryptocurrency coins to the owner of the possession;
wherein the computer program ensures that the cryptocurrency coins are recorded in the blockchain ledger.

18. The invention of claim 16, wherein the possession is art.

19. The invention of claim 16, wherein the possession is intellectual property.

20. The invention of claim 19, wherein the intellectual property is a patent.
